(19) United States
(12) Patent Application Publication
(10) Pub. No.: US 2024/0223849 A1
(43) Pub. Date: Jul. 4, 2024

(54) LIVE-STREAMING VIDEO STREAM PLAYING METHOD AND APPARATUS, AND ELECTRONIC DEVICE AND STORAGE MEDIUM

(71) Applicant: Beijing Bytedance Network Technology Co., Ltd., Beijing (CN)

(72) Inventors: Wenjing LIU, Beijing (CN); Hui XUAN, Beijing (CN); Linxing LI, Beijing (CN); Kun JIANG, Beijing (CN)

(21) Appl. No.: 18/562,926

(22) PCT Filed: May 12, 2022
(86) PCT No.: PCT/CN2022/092515

§ 371 Date: Nov. 21, 2023

(30) Foreign Application Priority Data
May 21, 2021 (CN) 202110560599.4

(51) Int. Cl. H04N 21/4402; H04N 21/2187; H04N 21/414; H04N 21/472

(52) U.S. Cl. CPC H04N 21/440263; H04N 21/2187; H04N 21/41407; H04N 21/472

(57) ABSTRACT

The present disclosure provides a method and apparatus for playing a live video stream, an electronic device, and a storage medium. The method can be applied to a terminal device with a display screen. A video stream of a target live room is received and a video size of the video stream is determined; a direction of rotation of the terminal device is detected; a playing size of the video stream on the display screen is determined according to the video size of the video stream and the direction of rotation; and the video stream is played in the playing size.

### CROSS-REFERENCE TO RELATED APPLICATION

This patent application claims the priority to Chinese Patent Application No. 202110560599.4 filed on May 21, 2021 and entitled “LIVE VIDEO STREAM PLAYING METHOD AND DEVICE, ELECTRONIC EQUIPMENT AND STORAGE MEDIUM”, the disclosure of which is incorporated by reference herein in its entirety as part of the present application.

### TECHNICAL FIELD

Embodiments of the present disclosure relate to the technical field of streaming media, and in particular, to a method and apparatus for playing a live video stream, an electronic device, and a storage medium.

### BACKGROUND

With the development of the live streaming industry, live streaming applications (APPs) corresponding to live streaming platforms have become hot APPs among various APPs. By running a live streaming APP on a terminal device, streaming media transmitted by a live streaming platform server can be received and played on the terminal device.

### SUMMARY

Embodiments of the present disclosure provide a method and apparatus for playing a live video stream, an electronic device, and a storage medium to overcome a problem that a terminal device is incapable of playing a live video stream according to a direction of rotation.

In a first aspect, embodiments of the present disclosure provide a method for playing a live video stream which is applied to a terminal device with a display screen, and the method includes: receiving a video stream of a target live room and determining a video size of the video stream; detecting a direction of rotation of the terminal device; and determining a playing size of the video stream on the display screen according to the video size of the video stream and the direction of rotation, and playing the video stream in the playing size.

In a second aspect, embodiments of the present disclosure provide an apparatus for playing a live video stream. The apparatus includes:
a receiving module configured to receive a video stream of a target live room and determine a video size of the video stream;
a detection module configured to detect a direction of rotation of the terminal device; and
a display module configured to determine a playing size of the video stream on the display screen according to the video size of the video stream and the direction of rotation, and play the video stream in the playing size.

In a third aspect, embodiments of the present disclosure provide an electronic device. The electronic device includes at least one processor and a memory,
the memory stores computer-executable instructions; and
the at least one processor executes the computer-executable instructions stored on the memory, causing the at least one processor to execute the method for playing live video stream described in the first aspect and various possible designs of the first aspect.

In a fourth aspect, embodiments of the present disclosure provide a computer-readable storage medium, storing computer-executable instructions, wherein when the computer-executable instructions are executed by a processor, the method for playing live video stream described in the first aspect and various possible designs of the first aspect is implemented.

In a fifth aspect, embodiments of the present disclosure provide a computer program product, comprising a computer program, wherein when the computer program is executed by a processor, the method for playing live video stream described in the first aspect and various possible designs of the first aspect is implemented.

In a sixth aspect, embodiments of the present disclosure provide a computer program, wherein when the computer program is executed by a processor, the method for playing live video stream described in the first aspect and various possible designs of the first aspect is implemented.

### BRIEF DESCRIPTION OF THE DRAWINGS

In order to provide a clear explanation of the technical solutions in the disclosed embodiments or related technologies, a brief introduction will be given to the accompanying drawings required in the embodiments or related technical descriptions. It is obvious that the accompanying drawings in the following description are parts of embodiments of the present disclosure. For ordinary technical personnel in the art, other accompanying drawings can be obtained based on these drawings without any creative effort.

FIG. 1 is a diagram of an application scenario of a method for playing a live video stream provided in embodiments of the present disclosure;

FIG. 2 is a schematic diagram of playing a live video stream by a terminal device at different rotation angles in related art;

FIG. 3 is a first flowchart of a method for playing a live video stream provided in embodiments of the present disclosure;

FIG. 4 is a schematic diagram of video streams of different video sizes provided in embodiments of the present disclosure;

FIG. 5 is a schematic diagram of a direction of rotation of a terminal device provided in embodiments of the present disclosure;

FIG. 6 is a second flowchart of a method for playing a live video stream provided in embodiments of the present disclosure;

FIG. 7 is a schematic diagram of a playing size provided in embodiments of the present disclosure;

FIG. 8 is a schematic diagram of another playing size provided in embodiments of the present disclosure;

FIG. 9 is a structural block diagram of an apparatus for playing a live video stream provided in embodiments of the present disclosure;

FIG. 10 is a structural schematic diagram of an electronic device provided in embodiments of the present disclosure; and

FIG. 11 is a schematic diagram of a hardware structure of an electronic device provided in embodiments of the present disclosure.

### DETAILED DESCRIPTION

In order to make the purpose, technical solution, and advantages of the disclosed embodiments clearer, the following will provide a clear and complete description of the technical solution in the disclosed embodiments in conjunction with the accompanying drawings. Obviously, the described embodiments are a part of the disclosed embodiments, not all of them. Based on the embodiments in this disclosure, all other embodiments obtained by ordinary technical personnel in the art without creative effort fall within the scope of protection in this disclosure.

In the related art, when playing live videos, terminal devices of different types and sizes can only play the live videos in in a vertical screen format. Even though a terminal device is placed in landscape mode, since a live video stream cannot rotate along with the rotation of the terminal device, the terminal device may play the live video still in the vertical screen format, leading to use limitation of the terminal device and affecting the convenience and experience of a user.

An application scenario of embodiments of the present disclosure will be explained below.

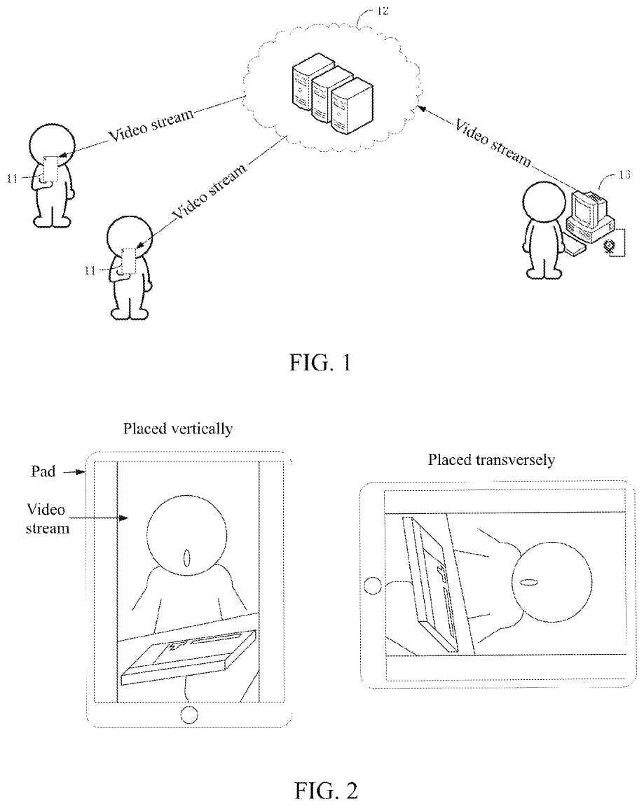

FIG. 1 is a diagram of an application scenario of a method for playing a live video stream provided in embodiments of the present disclosure. The method for playing a live video stream provided in the embodiments of the present disclosure can be applied to the application scenario of live video streaming. Specifically, as shown in FIG. 1, for example, the performing entity of the method for playing a live video stream provided in the embodiments may be a first terminal device 11 of a viewer user. The first terminal device 11 is in communication with a cloud server 12 of a live streaming platform to receive a video transmitted by the cloud server 12, decode the video stream in real time, and display video images on a display screen, thus realizing a live video playing. A second terminal device 13 of an anchor user is on the other side of connection to the cloud server 12. The second terminal device 13 captures a live video and transmits the live video stream to the cloud server 12 so that the viewer user can receive the live video stream transmitted by the second terminal device 13 through the cloud server 12 when visiting a live room of the anchor user through the first terminal device 11 and then view the live video of the live room. A live streaming APP runs in the first terminal device 11. The process of receiving the video stream transmitted by the cloud server 12 and decoding the video stream for playing may be realized through the live streaming APP. The specific process will not be described here redundantly.

In the related technology, in the particular application scenario of live video streaming, for terminal devices of different types and sizes, when playing a live video, even though placed in landscape mode, a terminal device can only play the live video in portrait mode because a live video stream cannot rotate along with the rotation of the terminal device. FIG. 2 is a schematic diagram of playing a live video stream by a terminal device at different rotation angles in the related technology. As shown in FIG. 2, the terminal device is, for example, a Pad. When the Pad is placed in a vertical direction, the live video stream is played in the vertical direction of the Pad. However, when the Pad is placed in a transverse direction, the live video stream is still played in the vertical direction of the Pad. Thus, it is inconvenient for a user to view the Pad. As a result, the user cannot view the live video by transversely using the Pad, and the use convenience of the user is affected.

The reason that the terminal device can only play a live video in portrait mode in the related technology is as follows: since video streams transmitted by different live rooms have different video sizes, when the terminal device plays video streams, the video streams of different video sizes may typically be scaled up and down to corresponding extents according to a size of a display screen of the terminal device to realize the optimal display effect matching the size of the display screen. When the terminal device is rotated, a change in the transverse-vertical relationship of the display screen may also cause a change in the scaling ratio of the video stream such that the terminal device is incapable of determining the accurate playing size of the video stream. Therefore, in the related technology, the live video stream is played fixedly in portrait mode, and the playing size of the video stream cannot be automatically adjusted according to a rotation angle of the terminal device.

To solve the above technical problems, embodiments of the present disclosure provide a method and apparatus for playing a live video stream, an electronic device, and a storage medium.

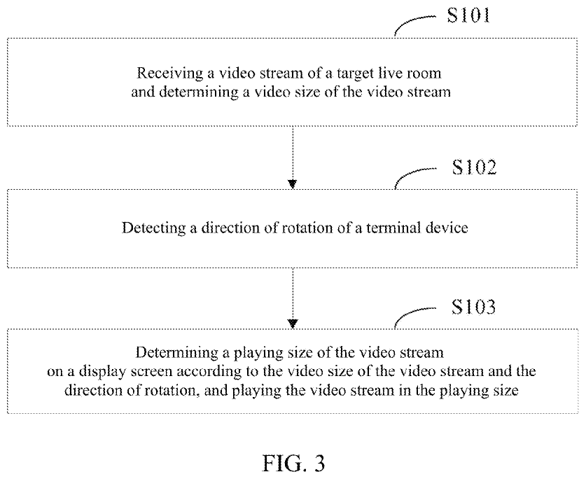

FIG. 3 is a first flowchart of a method for playing a live video stream provided in embodiments of the present disclosure. As shown in FIG. 3, the method of the present embodiments may be applied to a terminal device with a display screen, such as a smart phone and a Pad. The method for playing a live video stream includes the following steps.

Step S101: a video stream of a target live room is received and a video size of the video stream is determined.

Exemplarily, a live streaming client, i.e., a live streaming APP runs in the terminal device. After the target live room is determined, a video stream corresponding to the target live room transmitted by a server is received, where the video stream is video data pushed by a live streaming terminal corresponding to the target live room based on a stream transmission manner. A specific implementation of transmitting the video stream by an anchor side terminal device through a cloud server to a viewer side terminal device is the related technology known to a person skilled in the art, which will not be redundantly described here.

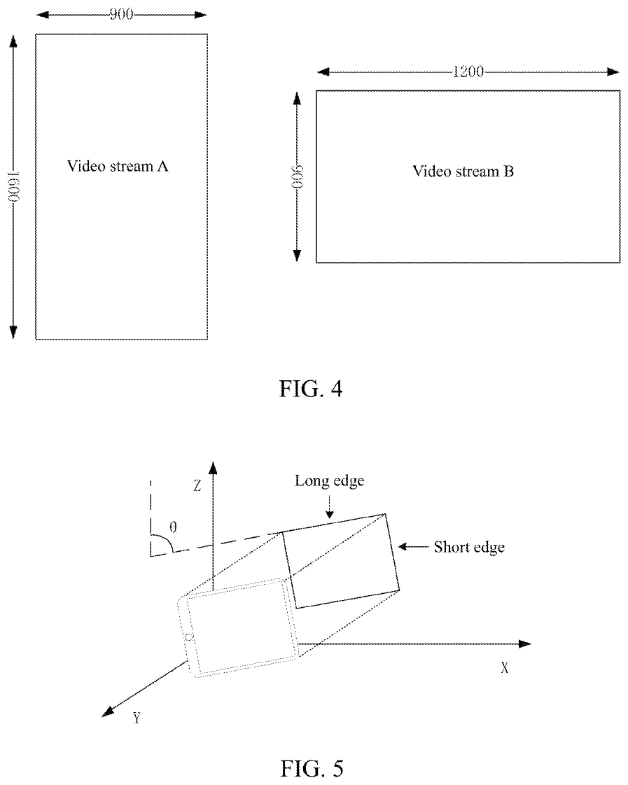

Further, the terminal device may determine the video size of the video stream by parsing the video stream after obtaining the video stream. Exemplarily, the video size may refer to a resolution of the video stream. The video size is based on a device that shoots the video to be played corresponding to the video stream. FIG. 4 is a schematic diagram of video streams of different video sizes provided in embodiments of the present disclosure. As shown in FIG. 4, for example, a video corresponding to a video stream A is shot by a smart phone, and has a video size of 900*1600 and a length-width ratio of 9:16. A video corresponding to a video stream B is generated by screen recording on a computer, and has a video size of 1200*900 and a length-width ratio of 4:3.

Step S102: a direction of rotation of the terminal device is detected.

Exemplarily, the direction of rotation of the terminal device is a spatial state of the terminal device. The direction of rotation includes a first direction and a second direction, where the first direction corresponds to the terminal device being in landscape mode and the second direction corresponds to the terminal device being in portrait mode. FIG. 5 is a schematic diagram of a direction of rotation of a terminal device provided in embodiments of the present disclosure. As shown in FIG. 5, the terminal device has a rectangular display screen including a long edge and a short edge. Exemplarily, an included angle between a projection of the long edge in X-Z plane and Y-Z plane is a rotation angle (shown as θ in the figure). When the rotation angle is within a first preset interval, the direction of rotation is a first direction, i.e., the terminal device is in landscape mode. When the rotation angle is within a second preset interval, the direction of rotation is a second direction, i.e., the terminal device is in portrait mode.

In an alternative implementation manner, the direction of rotation of the terminal device may be detected by a gravity detection unit disposed in the terminal device. More specifically, gravity sensing information collected by the gravity detection unit of the terminal device is obtained, and the direction of rotation is determined according to the gravity sensing information. The gravity detection unit is, for example, a three-dimensional gyroscope.

Step S103: a playing size of the video stream on the display screen is determined according to the video size of the video stream and the direction of rotation, and the video stream is played in the playing size.

Exemplarily, after the video size of the video stream is determined, a size (i.e., the playing size) matching a screen size and the direction of rotation may be determined according to the direction of rotation of the terminal device, and the video stream is played in the playing size to achieve the optimal video presentation effect. Exemplarily, the playing size is a maximum diagonal size that the display screen can accommodate without unilaterally stretching the video stream and without changing a view scale of the video stream, or any size less than the maximum diagonal size, e.g., 0.8 times the maximum diagonal size.

After the playing size is determined, the video stream is played in the playing size, and the live video corresponding to the video stream is displayed on the display screen to achieve the purpose of displaying live streaming contents. When the playing size is the maximum diagonal size that the display screen can accommodate, it is equivalent to a full-screen playing effect and better video immersion can be provided. When the playing size is a size less than the maximum diagonal size that the display screen can accommodate, other information (e.g., text information related to the video stream) may be displayed outside a video stream playing area corresponding to the playing size to meet the specific requirements of different live streaming application scenarios.

In the present embodiments, the video stream of the target live room is received and the video size of the video stream is determined; the direction of rotation of the terminal device is detected; the playing size of the video stream on the display screen is determined according to the video size of the video stream and the direction of rotation; and the video stream is played in the playing size. Since the playing size for playing the video stream is determined according to the direction of rotation of the terminal device and the video size of the video stream, the playing size can match the direction of rotation of the terminal device and the video size of the video stream. Thus, the terminal device is capable of playing the video stream in appropriate playing sizes in different directions of rotation. The display effect of the video stream is improved and the user's viewing experience is enhanced.

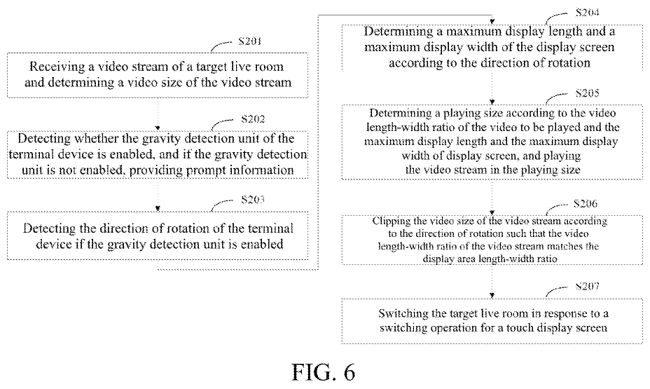

FIG. 6 is a second flowchart of a method for playing a live video stream provided in embodiments of the present disclosure. In the present embodiments, step S102 is further detailed and a step of switching target live rooms is added. The method for playing a live video stream includes the following steps.

Step S201: the video stream of the target live room is received and the video size of the video stream is determined.

Exemplarily, the video size includes a video length-width ratio of a video to be played corresponding to the video stream. The video length-width ratio is, for example, 4:3 or 16:9. An image length-width ratio of the video corresponding to the video stream may be determined from the video length-width ratio. Usually, the video length-width ratio is determined when the video stream is generated, and a specific value characterizing the video length-width ratio can be obtained by parsing the video stream. This process will not be described redundantly.

Step S202: whether the gravity detection unit of the terminal device is enabled is detected, and if the gravity detection unit is not enabled, prompt information is given.

Exemplarily, before the terminal device invokes a related function of the gravity detection unit, whether the gravity detection unit is enabled is detected first. Specifically, for example, an option for enabling and disabling the gravity detection unit is set in the operating system of the terminal device. The related setting in the operating system is detected by the device to determine whether the option is turned on, thereby determining whether the gravity detection unit is enabled. Then, when the gravity detection unit is disabled, the user is prompted to enable the gravity detection unit by popping up prompt information in the live streaming APP to realize the detection on the direction of rotation of the terminal device. The specific content of the prompt information may be set as needed, which will not be described here redundantly.

Further, after the function of the gravity detection unit is enabled, a function (such as “the screen direction rotates automatically”) of the terminal device may be realized. In some scenarios, this function may be selectively enabled according to the requirement of the user and is not a “normally open” option. In the present embodiment, the gravity detection function is detected, and when viewing a live video, the function of the gravity detection unit may be enabled in advance to realize the detection on the direction of rotation of the terminal device and improve the use convenience.

Step S203: if the gravity detection unit is enabled, the direction of rotation of the terminal device is detected.

Further, if it is detected that the gravity detection unit is enabled, the direction of rotation of the terminal device is detected by the gravity detection unit, where the gravity detection unit is, for example, the three-dimensional gyroscope. The specific implementation may be as shown in the description of step S102 in the embodiments shown in FIG. 3, which will not be described here redundantly.

Step S204: a maximum display length and a maximum display width of the display screen are determined according to the direction of rotation.

Alternatively, the display screen has a maximum display area. A long edge size of the maximum display area is a first length, and a short edge size of the maximum display area is a second length. Step S204 includes two specific implementations: steps S2041 and S2042.

Step S2041: when the direction of rotation is a first direction, the maximum display length is determined as the first length and the maximum display width as the second length. The first direction corresponds to a direction of the terminal device placed in landscape mode.

Step S2042: when the direction of rotation is a second direction, the maximum display length is determined as the second length and the maximum display width as the first length. The second direction corresponds to a direction of the terminal device placed in portrait mode.

Exemplarily, the long edge size and the short edge size (i.e., the first length and the second length) of the maximum display area are recorded in the hardware information of the terminal device. The long edge size and the short edge size of the maximum display area may be determined by reading the hardware information of the terminal device. Further, by detecting the direction of rotation of the terminal device, i.e., whether the terminal device is placed in landscape mode or portrait mode, maximum display sizes of the terminal device in different directions of rotations are determined correspondingly. More specifically, for example, when the terminal is placed in landscape mode, the maximum display length is the long edge size (e.g., 1280 (pixels)) of the display screen of the terminal device, and the maximum display width is the short edge size (e.g., 720 (pixels)) of the display screen of the terminal device. When the terminal is placed in portrait mode, the maximum display length is the short edge size (e.g., 720 (pixels)) of the display screen of the terminal device, and the maximum display width is the long edge size (e.g., 1280 (pixels)) of the display screen of the terminal device.

Step S205: a playing size is determined according to the video length-width ratio of the video to be played and the maximum display length and the maximum display width of display screen, and the video stream is played in the playing size.

Alternatively, the playing size includes a playing area length and a playing area width. Step S205 includes the following two specific implementation steps S2051 and S2052.

S2051: a display area length-width ratio is determined according to a ratio of the maximum display length to the maximum display width.

S2052: if the display area length-width ratio is greater than the video length-width ratio, the playing area width is determined as the second length and the playing area length is determined as a product of the second length and the length-width ratio; and if the display area length-width ratio is less than the video length-width ratio, the playing area length is determined as the first length and the playing area width is determined as a ratio of the first length to the video length-width ratio.

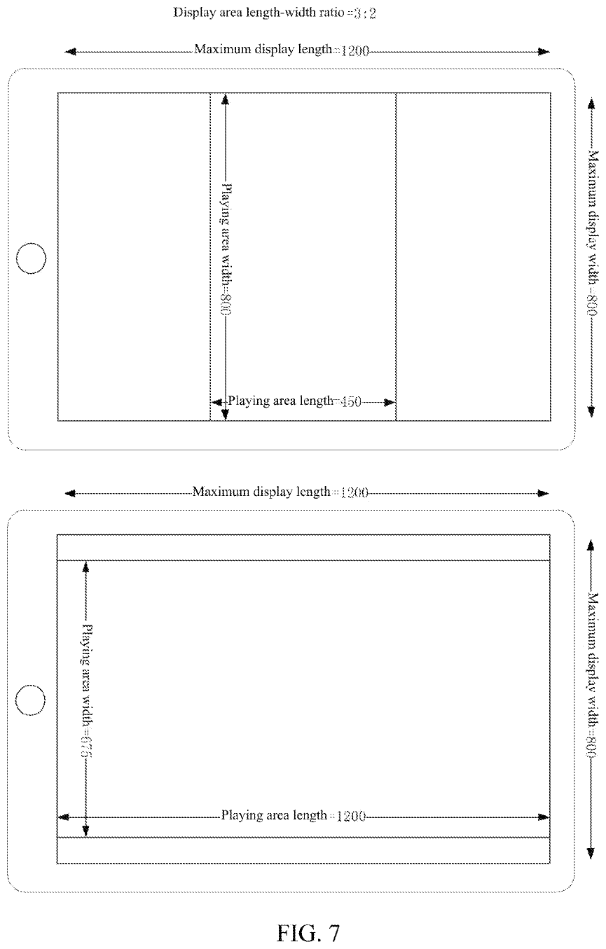

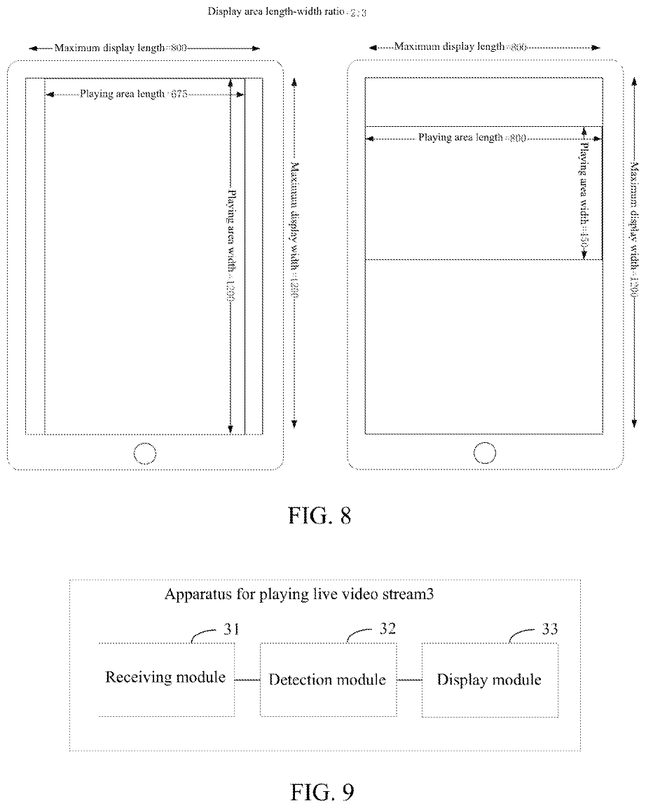

Exemplarily, after the direction of rotation of the terminal device is determined, the display area length-width ratio of the terminal device in the direction of rotation may be determined, and then a maximum playing size that can be supported by the display screen to play a video stream may be determined according to a relationship between the display area length-width ratio and the video length-width ratio. Exemplarily, the maximum playing size may be the playing size. FIG. 7 is a schematic diagram of a playing size provided in an embodiment of the present disclosure. As shown in FIG. 7, the playing size includes a playing area length and a playing area width, where a playing area may be located in the middle of the display screen, and the display screen has a resolution of 1200*800 (pixels). As a matter of course, the playing area may also be located in other positions of the display screen as needed, which will not be described repeatedly herein. When the terminal device is located in the first direction, i.e., the terminal device is placed in landscape mode, the display area length-width ratio is 3:2 (the maximum display width is 800 and the maximum display length is 1200). Then, according to the video length-width ratio of the video to be played, there may be two cases. For example, if the display area length-width ratio is greater than the video length-width ratio (e.g., the video length-width ratio is 9:16), the playing area width is the maximum display width (800), and the playing area length is a product (450) of the maximum display width and the video length-width ratio. If the display area length-width ratio is less than the video length-width ratio (e.g., the video length-width ratio is 16:9), the playing area length is the maximum display length (1200), and the playing area width is a ratio (675) of the maximum display length to the video length-width ratio. FIG. 8 is a schematic diagram of another playing size provided in an embodiment of the present disclosure. As shown in FIG. 8, correspondingly, when the terminal device is located in the second direction, i.e., the terminal device is placed in portrait mode, the display area length-width ratio is 2:3 (the maximum display width is 1200 and the maximum display length is 800). According to the video length-width ratio of the video to be played, there may be two cases. If the display area length-width ratio is greater than the video length-width ratio (e.g., the video length-width ratio is 9:16), the playing area width is the maximum display width (1200), and the playing area length is a product (675) of the maximum display width and the video length-width ratio. If the display area length-width ratio is less than the video length-width ratio (e.g., the video length-width ratio is 16:9), the playing area length is the maximum display length (800), and the playing area width is a ratio (450) of the maximum display length to the video length-width ratio.

In the present embodiment, the maximum playing size of the video to be played on the display screen is determined by determining the direction of rotation of the terminal device and the video length-width ratio of the video to be played corresponding to the video stream. Thus, when the terminal device is rotated, the video to be played can be played in an optimum size matching the rotation angle. The video display effect can be improved.

Alternatively, the method provided in the present embodiments further includes the following steps.

Step S206: the video size of the video stream is clipped according to the direction of rotation such that the video length-width ratio of the video stream matches the display area length-width ratio.

Exemplarily, in a specific application scenario, when the terminal device is rotated, if the video length-width ratio has a significant difference from the display area length-width ratio, it may cause a large blank area in the display screen. Meanwhile, for the true video stream content, due to a limited display area of the screen, the playing size is small, leading to the problem of poor display effect. In the present embodiments, when the direction of rotation changes and causing a significant difference between the video length-width ratio and a screen display length-width ratio, the video size of the video stream is clipped to change the video length-width ratio, thereby achieving the purpose of increasing the playing size and improving the video playing effect.

Step S207: the target live room is switched in response to a switching operation for a touch display screen.

Exemplarily, the switching operation may be a sliding operation, more specifically, e.g., an up-and-down sliding operation by the user along the screen. The terminal device responds to the sliding operation and then quits the current target live room, i.e., switches the video stream. In a possible implementation, the switching operation is a sliding operation corresponding to a direction of rotation. For example, when the terminal device is placed transversely, the target live room is switched by sliding transversely. When the terminal device is placed vertically, the target live room is switched by sliding vertically. Since the video streams in different target live rooms may have different playing sizes (e.g., some video streams are suitable for playing in landscape mode and some video streams are suitable for playing in portrait mode), and the operation habit of responding may also change after the direction of the terminal device is rotated by the user, the target live room is controlled to be switched according to the sliding operation corresponding to the direction of rotation in the present embodiment. The operation convenience of the user can be improved. Mis-operation can be prevented. The user experience can be enhanced.

In the present embodiments, the implementations of step S201 and step S203 are the same as those of steps S101 and step S102 in the embodiments shown in FIG. 2 of the present disclosure, which will not be redundantly described here one by one.

Corresponding to the method for playing a live video stream of the foregoing embodiments, FIG. 9 is a structural block diagram of an apparatus for playing a live video stream provided in embodiments of the present disclosure. For ease of description, only the parts related to the embodiments of the present disclosure are illustrated. With reference to FIG. 9, the apparatus for playing a live video stream 3 includes:
a receiving module 31 configured to receive a video stream of a target live room and determine video size of the video stream;
a detection module 32 configured to detect a direction of rotation of a terminal device; and
a display module 33 configured to determine a playing size of the video stream on the display screen according to the video size of the video stream and the direction of rotation, and play the video stream in the playing size.

In an embodiment of the present disclosure, the video size includes a video length-width ratio of a video to be played corresponding to the video stream. The display module 33 is specifically configured to: determine a maximum display length and a maximum display width of a display screen according to the direction of rotation; and determine the playing size according to the video length-width ratio of the video to be played and the maximum display length and the maximum display width of the display screen.

In an embodiment of the present disclosure, the display screen has a maximum display area. A long edge size of the maximum display area is a first length, and a short edge size of the maximum display area is a second length. The display module 33, when determining the maximum display length and the maximum display width of the display screen according to the direction of rotation, is specifically configured to: when the direction of rotation is a first direction, determine the maximum display length as the first length and the maximum display width as the second length, where the first direction corresponds to a direction of the terminal device placed in landscape mode; and when the direction of rotation is a second direction, determine the maximum display length as the second length and the maximum display width as the first length, where the second direction corresponds to a direction of the terminal device placed in portrait mode.

In one embodiment of the present disclosure, the playing size includes a playing area length and a playing area width. The display module 33, when determining the playing size according to the video length-width ratio of the video to be played and the maximum display length and the maximum display width of the display screen, is specifically configured to: determine a display area length-width ratio according to a ratio of the maximum display length to the maximum display width; if the display area length-width ratio is greater than the video length-width ratio, determine the playing area width as the maximum display width and the playing area length as a product of the maximum display width and the length-width ratio; and if the display area length-width ratio is less than the video length-width ratio, determine the playing area length as the maximum display length and the playing area width as a ratio of the maximum display length to the video length-width ratio.

In an embodiment of the present disclosure, the display module 33 is further configured to: clip the video size of the video stream according to the direction of rotation such that the video length-width ratio of the video stream matches the display area length-width ratio, where the display area length-width ratio is the ratio of the maximum display length to the maximum display width.

In an embodiment of the present disclosure, the detection module 32 is specifically configured to: obtain gravity sensing information collected by a gravity detection unit of the terminal device; and determine the direction of rotation according to the gravity sensing information.

In an embodiment of the present disclosure, the detection module 32 is further configured to: detect whether the gravity detection unit of the terminal device is enabled, and if the gravity detection unit is not enabled, give prompt information.

In an embodiment of the present disclosure, the display screen is a touch display screen. The display module 33 is further configured to switch the target live room in response to a switching operation for the touch display screen.

In an embodiment of the present disclosure, the switching operation is a sliding operation corresponding to a direction of rotation.

The apparatus for playing a live video stream provided in the present embodiments can be configured to perform the technical solutions of the method embodiments described above, and may follow similar implementation principles and have similar technical effects to the method embodiments, which will not be redundantly described herein.

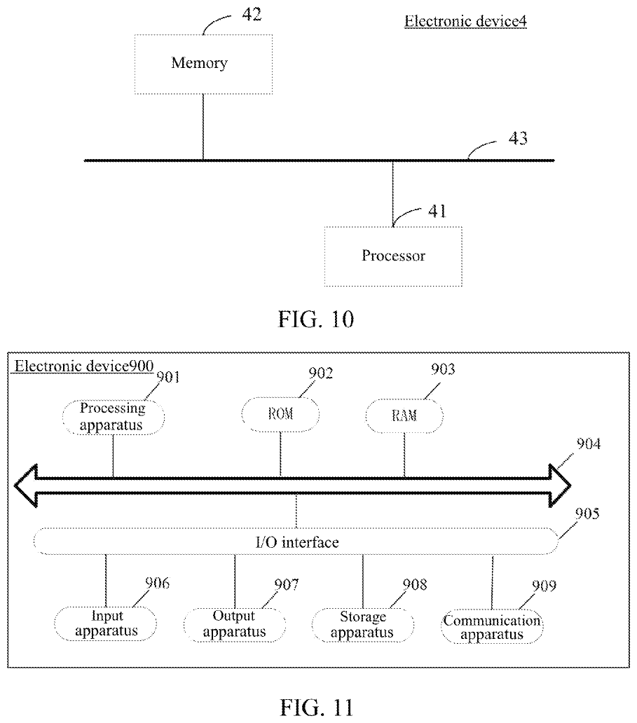

FIG. 10 is a structural schematic diagram of an electronic device provided in embodiments of the present disclosure. As shown in FIG. 10, the electronic device 4 includes at least one processor 41 and a memory 42.

The memory 42 stores computer-executable instructions.

The at least one processor 41 executes the computer-executable instructions stored on the memory 42 to perform the method for playing a live video stream in the embodiments shown in FIG. 3 to FIG. 8.

The processor 41 and the memory 42 are connected by means of a bus 43.

A reference may be made to the corresponding related descriptions and effects of the steps in the embodiments correspondingly shown in FIG. 3 to FIG. 8, which will not be described redundantly here.

With reference to FIG. 11 which illustrates a structural schematic diagram of an electronic device 900 adapted to implement the embodiments of the present disclosure, the electronic device 900 may be a terminal device or a server. The terminal device may include but not be limited to mobile terminals such as a mobile phone, a notebook computer, a digital streaming receiver, a personal digital assistant (PDA), a portable Android device (PAD), a portable media player (PMP), and a vehicle-mounted terminal (e.g., a vehicle-mounted navigation terminal), and fixed terminals such as a digital TV and a desktop computer. The electronic device shown in FIG. 11 is merely an example, and should not pose any limitation to the functions and the range of use of the embodiments of the present disclosure.

As shown in FIG. 11 the electronic device 900 may include a processing apparatus (e.g., a central processing unit, or a graphics processing unit) 901, which can perform various suitable actions and processing according to a program stored on a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected by means of a bus 904. An input/output (I/O) interface 905 is also connected to the bus 904.

Usually, the following apparatuses may be connected to the I/O interface 905: an input apparatus 906 including, for example, a touch screen, a touch pad, a keyboard, a mouse, a camera, a microphone, an accelerometer, and a gyroscope; an output apparatus 907 including, for example, a liquid crystal display (LCD), a loudspeaker, and a vibrator; a storage apparatus 908 including, for example, a magnetic tape and a hard disk; and a communication apparatus 909. The communication apparatus 909 may allow the electronic device 900 to be in wireless or wired communication with other devices to exchange data. While FIG. 11 illustrates the electronic device 900 having various units, it is to be understood that all the illustrated apparatuses are not necessarily implemented or included. More or less apparatuses may be implemented or included alternatively.

Particularly, according to the embodiments of the present disclosure, the process described above with reference to the flowchart may be implemented as a computer software program. For example, the embodiment of the present disclosure includes a computer program product, which includes a computer program carried by a computer readable medium. The computer program includes a program code for executing the method shown in the flowchart. In such an embodiment, the computer program may be downloaded online through the communication apparatus 909 and installed, or installed from the storage apparatus 908, or installed from the ROM 902. When the computer program is executed by the processing apparatus 901, the functions defined in the method of the embodiments of the present disclosure are executed.

It needs to be noted that the computer readable medium described above in the present disclosure may be a computer readable signal medium or a computer readable storage medium or any combination thereof. For example, the computer-readable storage medium may be, but not limited to, an electric, magnetic, optical, electromagnetic, infrared, or semiconductor system, apparatus or device, or any combination of them. More specific examples of the computer-readable storage medium may include but be not limited to an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination thereof. In the present disclosure, the computer readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries thereon a computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable storage medium may send, propagate or transmit a program used by or in combination with an instruction execution system, apparatus or device. The program code included on the computer-readable medium may be transmitted by using any suitable medium, including but not limited to an electric wire, a fiber-optic cable, radio frequency (RF) and the like, or any appropriate combination thereof.

The above-mentioned computer-readable medium may be included in the electronic device described above, or may exist alone without being assembled with the electronic device.

The above-mentioned computer readable medium may carry one or more programs which, when executed by the electronic device, cause the electronic device to carry out the method illustrated in the above embodiments.

Computer program code for performing the operations in the present disclosure may be written in one or more programming languages or a combination thereof. The programming languages include object-oriented programming languages, such as Java, Smalltalk, and C++, and conventional procedural programming languages, such as C or similar programming languages. The program code can be executed fully on a user's computer, executed partially on a user's computer, executed as an independent software package, executed partially on a user's computer and partially on a remote computer, or executed fully on a remote computer or a server. In the scenario with a remote computer, the remote computer may be connected to the user's computer through any type of networks including a local area network (LAN) or a wide area network (WAN), or may be connected to an external computer (e.g., through the Internet connection from an Internet Service Provider).

The flowcharts and block diagrams in the accompanying drawings illustrate system architectures, functions and operations that may be implemented by the system, method and computer program product according to the embodiments of the present disclosure. In this regard, each block in the flowcharts or block diagrams may represent a module, a program segment or a part of code, and the module, the program segment or the part of code includes one or more executable instructions for implementing specified logic functions. It should also be noted that in some alternative implementations, functions marked in the blocks may also take place in an order different from the order designated in the accompanying drawings. For example, two consecutive blocks can actually be executed substantially in parallel, and they may sometimes be executed in a reverse order, which depends on involved functions. It should also be noted that each block in the flowcharts and/or block diagrams and combinations of the blocks in the flowcharts and/or block diagrams may be implemented by a dedicated hardware-based system for executing specified functions or operations, or may be implemented by a combination of dedicated hardware and computer instructions.

Related units described in the embodiments of the present disclosure may be implemented by software, or may be implemented by hardware. The name of a unit does not constitute a limitation on the unit itself. For example, a first acquisition unit may also be described as “a unit for obtaining at least two Internet protocol addresses”.

The functions described above herein may be performed at least in part by one or more hardware logic components. For example, exemplary types of hardware logic components that can be used without limitations include a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include but be not limited to an electronic, magnetic, optical, electromagnetic, infrared, or semiconductor system, apparatus or device, or any appropriate combination thereof. More specific examples of the machine-readable storage medium may include an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination thereof.

In a first aspect, according to one or more embodiments of the present disclosure, provided is a method for playing a live video stream, which is applied to a terminal device with a display screen and includes:
receiving a video stream of a target live room and determining a video size of the video stream; detecting a direction of rotation of the terminal device; determining a playing size of the video stream on the display screen according to the video size of the video stream and the direction of rotation, and playing the video stream in the playing size.

According to one or more embodiments of the present disclosure, the video size includes a video length-width ratio of a video to be played corresponding to the video stream; and the determining a playing size of the video stream on the display screen according to the video size of the video stream and the direction of rotation includes: determining a maximum display length and a maximum display width of the display screen according to the direction of rotation; and determining the playing size according to the video length-width ratio of the video to be played and the maximum display length and the maximum display width of the display screen.

According to one or more embodiments of the present disclosure, the display screen has a maximum display area; a long edge size of the maximum display area is a first length, and a short edge size of the maximum display area is a second length; and the determining a maximum display length and a maximum display width of the display screen according to the direction of rotation includes: when the direction of rotation is a first direction, determining the maximum display length as the first length and the maximum display width as the second length, where the first direction corresponds to a direction of the terminal device placed in landscape mode; and when the direction of rotation is a second direction, determining the maximum display length as the second length and the maximum display width as the first length, where the second direction corresponds to a direction of the terminal device placed in portrait mode.

According to one or more embodiments of the present disclosure, the playing size includes a playing area length and a playing area width; and the determining the playing size according to the video length-width ratio of the video to be played and the maximum display length and the maximum display width of the display screen includes: determining a display area length-width ratio according to a ratio of the maximum display length to the maximum display width; if the display area length-width ratio is greater than the video length-width ratio, determining the playing area width as the maximum display width and the playing area length as a product of the maximum display width and the length-width ratio; and if the display area length-width ratio is less than the video length-width ratio, determining the playing area length as the maximum display length and the playing area width as a ratio of the maximum display length to the video length-width ratio.

According to one or more embodiments of the present disclosure, the method further includes: clipping the video size of the video stream according to the direction of rotation such that the video length-width ratio of the video stream matches the display area length-width ratio, where the display area length-width ratio is the ratio of the maximum display length to the maximum display width.

According to one or more embodiments of the present disclosure, the detecting a direction of rotation of the terminal device includes: obtaining gravity sensing information collected by a gravity detection unit of the terminal device; and determining the direction of rotation according to the gravity sensing information.

According to one or more embodiments of the present disclosure, the method further includes: determining whether the gravity detection unit of the terminal device is enabled, and if the gravity detection unit is not enabled, giving prompt information.

According to one or more embodiments of the present disclosure, the display screen is a touch display screen, and the method further includes: switching the target live room in response to a switching operation for the touch display screen.

According to one or more embodiments of the present disclosure, the switching operation is a sliding operation corresponding to the direction of rotation.

In a second aspect, according to one or more embodiments of the present disclosure, provided is an apparatus for playing a live video stream, including:
a receiving module configured to receive a video stream of a target live room and determine a video size of the video stream;
a detection module configured to detect a direction of rotation of the terminal device; and
a display module configured to determine a playing size of the video stream on the display screen according to the video size of the video stream and the direction of rotation, and play the video stream in the playing size.

According to one or more embodiments of the present disclosure, the video size includes a video length-width ratio of a video to be played corresponding to the video stream; and the display module is specifically configured to: determine a maximum display length and a maximum display width of the display screen according to the direction of rotation; and determine the playing size according to the video length-width ratio of the video to be played and the maximum display length and the maximum display width of the display screen.

According to one or more embodiments of the present disclosure, the display screen has a maximum display area; a long edge size of the maximum display area is a first length, and a short edge size of the maximum display area is a second length; and the display module, when determining the maximum display length and the maximum display width of the display screen according to the direction of rotation, is specifically configured to: when the direction of rotation is a first direction, determine the maximum display length as the first length and the maximum display width as the second length, where the first direction corresponds to a direction of the terminal device placed in landscape mode; and when the direction of rotation is a second direction, determine the maximum display length as the second length and the maximum display width as the first length, where the second direction corresponds to a direction of the terminal device placed in portrait mode.

According to one or more embodiments of the present disclosure, the playing size includes a playing area length and a playing area width; and the display module, when determining the playing size according to the video length-width ratio of the video to be played and the maximum display length and the maximum display width of the display screen, is specifically configured to: determine a display area length-width ratio according to a ratio of the maximum display length to the maximum display width; if the display area length-width ratio is greater than the video length-width ratio, determine the playing area width as the maximum display width and the playing area length as a product of the maximum display width and the length-width ratio; and if the display area length-width ratio is less than the video length-width ratio, determine the playing area length as the maximum display length and the playing area width as a ratio of the maximum display length to the video length-width ratio.

According to one or more embodiments of the present disclosure, the display module is further configured to clip the video size of the video stream according to the direction of rotation such that the video length-width ratio of the video stream matches the display area length-width ratio, where the display area length-width ratio is the ratio of the maximum display length to the maximum display width.

According to one or more embodiments of the present disclosure, the detection module is specifically configured to: obtain gravity sensing information collected by a gravity detection unit of the terminal device; and determine the direction of rotation according to the gravity sensing information.

According to one or more embodiments of the present disclosure, the detection module is further configured to: determine whether the gravity detection unit of the terminal device is enabled, and if the gravity detection unit is not enabled, give prompt information.

According to one or more embodiments of the present disclosure, the display screen is a touch display screen; and the display module is further configured to switch the target live room in response to a switching operation for the touch display screen.

According to one or more embodiments of the present disclosure, the switching operation is a sliding operation corresponding to the direction of rotation.

In a third aspect, according to one or more embodiments of the present disclosure, an electronic device is provided, the device includes at least one processor and a memory.

The memory stores computer-executable instructions.

The at least one processor executes the computer-executable instructions stored on the memory and is caused to perform the method for playing a live video stream described in the first aspect and various possible designs of the first aspect.

In a fourth aspect, according to one or more embodiments of the present disclosure, provided is a computer-readable storage medium. Computer-executable instructions are stored on the computer-readable storage medium, and when a processor executes the computer-executable instructions, the method for playing a live video stream described in the first aspect and various possible designs of the first aspect is performed.

In a fifth aspect, an embodiment of the present disclosure provides a computer program product, including a computer program. When the computer program is executed by a processor, the method for playing a live video stream described in the first aspect and various possible designs of the first aspect is performed.

In a sixth aspect, an embodiment of the present disclosure provides a computer program. When the computer program is executed by a processor, the method for playing a live video stream described in the first aspect and various possible designs of the first aspect is performed.

The method and apparatus for playing a live video stream, an electronic device, and a storage medium provided in the embodiments can be applied to a terminal device with a display screen. A video stream of a target live room is received and a video size of the video stream is determined; a direction of rotation of the terminal device is detected; a playing size of the video stream on the display screen is determined according to the video size of the video stream and the direction of rotation; and the video stream is played in the playing size. Since the playing size for playing the video stream is determined according to the direction of rotation of the terminal device and the video size of the video stream, the playing size is capable of matching the direction of rotation of the terminal device and the video size of the video stream. Thus, the terminal device is capable of playing the video stream in appropriate playing sizes in different directions of rotation. The display effect of the video stream is improved and the user's viewing experience is enhanced.

The above description is only related to preferred embodiments of this disclosure and explanations of the technical principles. Those skilled in the art should understand that the scope of disclosure referred to in this disclosure is not limited to technical solutions formed by specific combinations of the aforementioned technical features, but also covers other technical solutions formed by arbitrary combinations of the aforementioned technical features or their equivalent features without departing from the aforementioned disclosed concept. For example, a technical solution formed by replacing the above features with (but not limited to) technical features with similar functions disclosed in this disclosure.

Furthermore, although each operation is depicted in a specific order, this should not be understood as requiring them to be executed in the specific order shown or in a sequential order. In certain environments, multitasking and parallel processing may be advantageous. Similarly, although several specific implementation details are included in the above discussion, these should not be interpreted as limiting the scope of this disclosure. Some features described in the context of individual embodiments can also be combined and implemented in a single embodiment. On the contrary, various features described in the context of a single embodiment can also be implemented individually or in any suitable sub-combination in multiple embodiments.

Although the present subject matter has been described in language specific to structural features and/or method logical actions, it should be understood that the subject matter limited in the attached claims may not necessarily be limited to the specific features or actions described above. On the contrary, the specific features and actions described above are only exemplary forms of implementing the claims.

1. A method for playing a live video stream, applied to a terminal device with a display screen and comprising:
receiving a video stream of a target live room and determining a video size of the video stream;
detecting a direction of rotation of the terminal device; and
determining a playing size of the video stream on the display screen according to the video size of the video stream and the direction of rotation, and playing the video stream in the playing size.

2. The method according to claim 1, wherein the video size comprises a video length-width ratio of a video to be played corresponding to the video stream; and
the determining a playing size of the video stream on the display screen according to the video size of the video stream and the direction of rotation comprises:
determining a maximum display length and a maximum display width of the display screen according to the direction of rotation; and
determining the playing size according to the video length-width ratio of the video to be played and the maximum display length and the maximum display width of the display screen.

3. The method according to claim 2, wherein the display screen has a maximum display area, a long edge size of the maximum display area is a first length, and a short edge size of the maximum display area is a second length; and
the determining a maximum display length and a maximum display width of the display screen according to the direction of rotation comprises:
when the direction of rotation is a first direction, determining the maximum display length as the first length and the maximum display width as the second length, wherein the first direction corresponds to a direction of the terminal device placed in landscape mode; and
when the direction of rotation is a second direction, determining the maximum display length as the second length and the maximum display width as the first length, wherein the second direction corresponds to a direction of the terminal device placed in portrait mode.

4. The method according to claim 3, wherein the playing size comprises a playing area length and a playing area width, and the determining the playing size according to the video length-width ratio of the video to be played and the maximum display length and the maximum display width of the display screen comprises:
determining a display area length-width ratio according to a ratio of the maximum display length to the maximum display width;
if the display area length-width ratio is greater than the video length-width ratio, determining the playing area width as the maximum display width and the playing area length as a product of the maximum display width and the length-width ratio; and if the display area length-width ratio is less than the video length-width ratio, determining the playing area length as the maximum display length and the playing area width as a ratio of the maximum display length to the video length-width ratio.

5. The method according to claim 4, further comprising:
clipping the video size of the video stream according to the direction of rotation such that the video length-width ratio of the video stream matches the display area length-width ratio, wherein the display area length-width ratio is the ratio of the maximum display length to the maximum display width.

6. The method according to claim 1, wherein the detecting a direction of rotation of the terminal device comprises:
obtaining gravity sensing information collected by a gravity detection unit of the terminal device; and
determining the direction of rotation according to the gravity sensing information.

7. The method according to claim 6, further comprising:
determining whether the gravity detection unit of the terminal device is enabled, and if the gravity detection unit is not enabled, providing prompt information.

8. The method according to claim 1, wherein the display screen is a touch display screen; and the method further comprises:
switching the target live room in response to a switching operation for the touch display screen.

9. The method according to claim 8, wherein the switching operation is a sliding operation corresponding to the direction of rotation.

10. An apparatus for playing a live video stream, comprising:
a receiving module configured to receive a video stream of a target live room and determine a video size of the video stream;
a detection module configured to detect a direction of rotation of the terminal device; and
a display module configured to determine a playing size of the video stream on the display screen according to the video size of the video stream and the direction of rotation, and play the video stream in the playing size.

11. An electronic device, comprising at least one processor and a memory,
wherein the memory stores computer-executable instructions; and
the at least one processor executes the computer-executable instructions stored on the memory, causing the electronic device to implement:
receive a video stream of a target live room and determining a video size of the video stream;
detect a direction of rotation of the terminal device; and
determine a playing size of the video stream on the display screen according to the video size of the video stream and the direction of rotation, and play the video stream in the playing size.

12. A computer-readable storage medium, storing computer-executable instructions, wherein when the computer-executable instructions are executed by a processor, the method for playing a live video stream according to claim 1 is implemented.

13. A computer program product, comprising a computer program, wherein when the computer program is executed by a processor, the method for playing a live video stream according to claim 1 is implemented.

14. A computer program, wherein when the computer program is executed by a processor, the method for playing a live video stream according to claim 1 is implemented.
